(19) United States
(12) Patent Application Publication
(10) Pub. No.: US 2026/0339746 A1
(43) Pub. Date: Oct. 29, 2026

(54) TRUST SCORE DRIVEN COMPOSABILITY

(71) Applicant: Dell Products L.P., Round Rock, TX (US)

(72) Inventors: Deepak Gaikwad, Natick, MA (US); Judith A. Furlong, Natick, MA (US); Raj Suryavanshi, Leander, TX (US)

(21) Appl. No.: 19/188,719

(22) Filed: Apr. 24, 2025

(51) Int. Cl. G06F 9/50

(52) U.S. Cl. CPC G06F 9/5077; G06F 9/505; G06F 2209/503; G06F 2209/508

(57) ABSTRACT

One example method includes receiving a user request that identifies base requirements needed for running a workload, translating the base requirements to a list of computing resources, identifying, from a resource inventory, which of the computing resources are available, selecting, based on respective trust scores of the computing resources, one or more of the available computing resources from the resource inventory, and composing a logical system that comprises the selected computing resources and is operable to execute the workload.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to deployment stacks in ZT (zero trust) environments. More particularly, at least some embodiments relate to systems, hardware, software, computer-readable media, and methods, for ensuring that components of a deployment stack are operating and behaving homogeneously throughout a workload lifecycle for that deployment stack.

### BACKGROUND

In a Zero Trust (ZT) environment, deployment stacks for workload runtimes are not generally pre-built but composed ad-hoc at runtime based on high level user intents. This is true for both on-prem and cloud deployments. The infrastructure that is leveraged to satisfy these user intents is comprised of resources which are policy driven and should account for enforcement of identities and access to device, network and applications. This becomes especially challenging since policies are not static but need to continuously evolve to address the dynamic threat landscape.

In the case of composable deployments, where an ad-hoc aggregation of heterogenous resource types such as compute, network, storage, and accelerators for example, is leveraged to satisfy desired workload outcomes, there is typically an overall composite policy that the system which includes those resources should strictly enforce for that workload.

However, enforcing this composite policy for the system is dependent on the resources that it comprises. The underlying dependent physical resources of the composed system need to provide assurance that they are operating and behaving homogenously throughout the workload lifecycle for that composed system. Thus, approaches are needed to provide this assurance that the security posture of the individual resources and that of the composed system is maintained effectively.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema, comprising a method and architecture, according to one embodiment.

FIG. 2 discloses aspects of a resource type trust score map, and associated according to one embodiment.

FIG. 3 discloses aspects of a computing entity that is configured and operable to perform any of the disclosed methods, processes, and operations.

### DETAILED DESCRIPTION OF SOME EXAMPLE EMBODIMENTS

Embodiments disclosed herein generally relate to deployment stacks in ZT (zero trust) environments. More particularly, at least some embodiments relate to systems, hardware, software, computer-readable media, and methods, for ensuring that components of a deployment stack are operating and behaving homogeneously throughout a workload lifecycle for that deployment stack.

Example embodiments comprise, methods, schemas, and architectures for implementing trust score-driven composability of an ad-hoc deployment stack used for performance of one or more workloads, such as in a ZT environment for example. A method according to one example embodiment may comprise various operations including, but not limited to: creating a graph model of physical and logical resources of a ZT environment; computing a trust score for each of the physical and logical resources; adding the trust scores as tags to nodes of the graph model that correspond to the physical and logical resources; receiving a user request that specifies resources needed for running a workload; composing a logical system comprising the resources; translating the logical system to a fine-grained implementation; identifying, based on the fine-grained implementation, those resources of a pool of resources that are best able to carry out the workload specified in the user request; and selecting, for execution of the workload, and based at least in part on the trust scores, the resources from the pool of resources. The selected resources may then be used to run the workload, with assurance that the resources collectively define a trustworthy system.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect an embodiment is that an architecture for performing a workload is composed of only resources that meet specified trustworthiness requirements. An embodiment may ensure that the security of a composed system, and the security of the underlying resources that make up the composed system, is maintained throughout the lifespan of the composed system. An embodiment may enable security policy enforcement, and anomaly detection, at an individual component level of a composed system. Various other advantages of one or more example embodiments will be apparent from this disclosure.

### A. Overview of aspects of an example embodiment

In an embodiment involving the definition and use of composable architectures, an orchestrator creates deployment stacks, also referred to herein as a runtime stack, or a ‘composed system,’ for workload runtimes by aggregating heterogenous resource types, examples of which include compute, network, storage, memory, and accelerators, to satisfy the desired workload outcomes as specified in user defined policies.

As part of the deployment of the runtime stack, a composite policy for the system which is aligned with the user defined policies is created. Compliance of the system with the composite policy may be continually monitored and maintained. As this composite policy is dependent on the resources that comprise the system, a method according to an embodiment provides assurance that the security posture of the composed system, and that of the underlying resources, is monitored and maintained effectively throughout the system lifecycle.

### B. Aspects of an example schema according to one embodiment

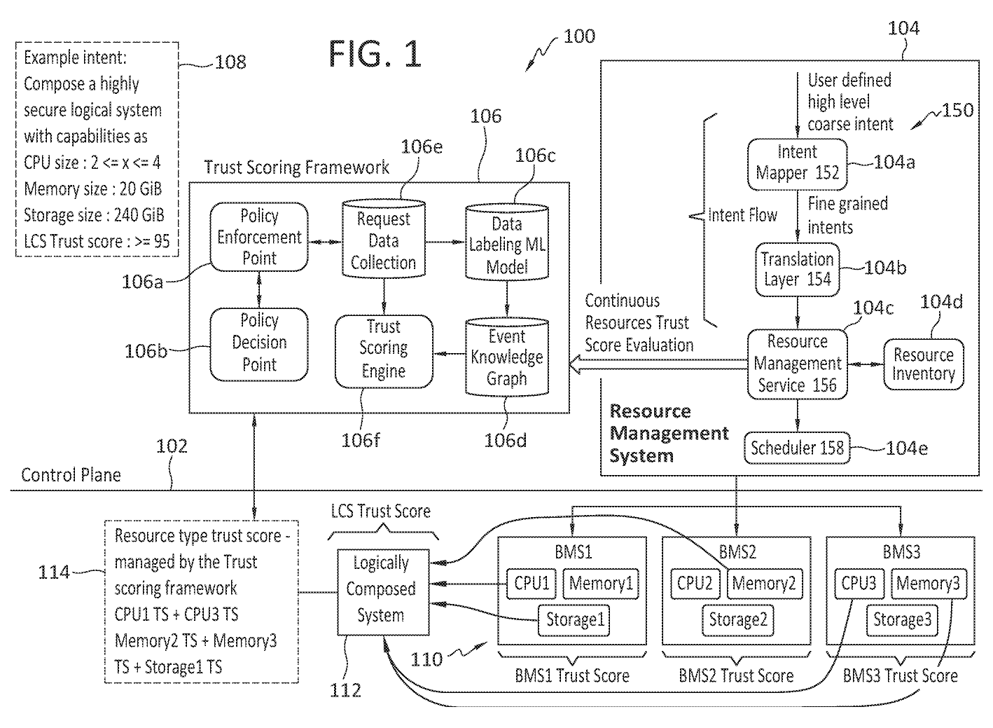

With attention now to FIG. 1, an example schema 100 according to one embodiment is disclosed. In this example, a control plane 102 may be provided that comprises a resource management system (RMS) 104 which is operable to implement a method according to an embodiment. Further details concerning an example of this method are provided below. The control plane 102 further comprises a trust scoring framework (TSF) 106. By way of brief overview, an example user intent 108, which may comprise various parameters, requirements, and policies, may be defined by a user and received and acted upon by an embodiment. In addition to the control plane 102 elements, the example schema 100 may comprise computing resources 110, such as various bare metal systems (BMS), and/or other computing resources, that may be associated together, based on the user intent 108, to define a logically composed system (LCS) 112 operable to perform a workload. The LCS 112 may have an associated trust score, generated and applied to the LCS 112 by the TSF 106. As shown, each of the computing resources 110, which may each comprise various elements such as CPU, memory, and storage, may be associated with a respective trust score. The TSF 106 may generate an overall trust score 114 for the logically composed system 112.

As indicated by the example of FIG. 1, the user intent 108 may be coarse in terms of its scope and level of detail. This example comprises a short list of broadly stated parameters, and while it identifies base requirements, which may be minimum requirements, it does not identify specific resources for carrying out the user-specified workloads.

With continued reference to FIG. 1, the example TSF 106 may operate in connection with the various components that make up the LCS 112. As shown, the TSF 106 may comprise various nodes or elements, and functions. These may include, but are not limited to, a policy enforcement point (PEP) 106a, a policy decision point (PDP) 106b, a data labeling ML model 106c, an event knowledge graph 106d, a data collection request module 106e, and a trust scoring engine 106f.

Internally, the TSF 106 may perform various operations. For example, based on the monitoring of the various computing resources 110, the PDP 106b may require that some type of action be performed with respect to the operation of those computing resources 110, and this policy may be enforced by the PEP 106a, such as by remediation instructions sent to the computing resources 110 and/or other entities. Data collection operations may be performed by the data collection request module 106e concerning any aspect of operations performed by the TSF 106 and the computing resources 110, and collected data may be labeled by the data labeling ML model 106c. In an embodiment, the event knowledge graph 106d may comprise a digital twin that represents a structure of the LCS 112. Finally, based at least in part on data collected concerning the computing resources 110 and/or concerning the LCS 112, the trust scoring engine 106f may assign a new or modified trust score to the LCS 112 and/or its individual computing resources 110. For example, if the data collected concerning the LCS 112 and/or its individual computing resources 110 indicates a possible security breach, the trust scoring engine 106f may assign a relatively low, or decreased, trust score to the LCS 112 and/or its individual computing resources 110.

### C. Aspects of the structure and operations of an example RMS

As noted above, an embodiment may comprise a resource management system, one example of which is shown at 104 in FIG. 1. The example RMS 104 may comprise various elements including, for example, an intent mapper 104a, a translation layer 104b, a resource management service 104c, resource inventory 104d, and a scheduler/optimizer 104e. The RMS 104 may be in ongoing communication with the TSF 106, so as to provide operational and security information, concerning resources managed by the RMS 104, to the TSF 106 that enables the TSF to generate trust score information for computing resources, such as the computing resources 110, managed by the RMS 104.

### C.1 Overview of an example method

The RMS 104 may operate to implement a method for managing resources such as may be used to form, possibly ad-hoc, a composable architecture for performance of one or more workloads. In an embodiment, the lifespan of the composable architecture may terminate once the workload(s) assigned to it have been completed.

By way of overview with respect to an example method implemented by the RMS 104, the RMS 104 tracks the inventory of available resources, such as the computing resources 110, during a discovery and onboarding process, and creates a graph model of the physical and logical computing resources 110 in a ZT environment.

Graph modeling may be used by the RMS 104 to create a graph representation comprising a hierarchy that provides the topology of the computing resources at a granular level, such as an individual component level. This graph representation comprises a digital twin of the physical and logical components that make up the computing resources 110. The graph modeling process may also capture the different resource capabilities and policies that are respectively associated with each of the individual computing resources 110.

The TSF 106 computes a trust score for each discovered resource in the inventory and adds them as an attribute/tag to the resource graph node. In an embodiment, there is a policy template used for each of the resource types as a baseline policy that may be enforced. Initially the trust score mat be at a maximum for available resources that have not yet been used in any architecture compositions.

As shown in FIG. 1, composing an LCS, such as the LCS 112 for example, may require a declaration of intents, from an end user, describing at a high level the requirements for running different workloads. The schedular/orchestrator 104e may translate the high-level intent received from the user to a fine-grained intent and may identify the best fit resources from a available resource pool. In an embodiment, schedular/orchestrator 104e may also look at the respective trust score metrics for each of the computing resources 110 in order to compose a trustworthy system that includes only those computing resources that have met an established threshold for trustworthiness.

### C.2 Detailed discussion of an example method implemented by an RMS

With continued attention to FIG. 1, a method 150 implemented by an RMS may comprise various operations. The method may be instantiated, in an embodiment, in response to input received from a user that has one or more workloads to be run.

As shown in FIG. 1, the method 150 may begin with receipt 152, by the intent mapper 104a, of a high level or ‘coarse’ expression of the intent of a user with respect to one or more workloads that the user needs performed. One example of a high level intent is shown at 108 in FIG. 1, and discussed above. The high level intent may specify various parameters and resource requirements relating to the execution of a workload, but may not specify any particular resources themselves. As discussed below, this flexible approach enables assignment of ‘best’ available resources to the workload, where the assignment of resources is not specifically constrained by the user but instead is left to the discretion of the RMS 104.

As part of the operation 152, the intent mapper 104a may then parse the high level coarse intent received from the user and map the broad parameters of the coarse intent to a set of fine grained intents. For example, if the coarse intents specify an overall trust score for the composed architecture, the fine grained intents may specify individual trust scores for one or more of the elements of the coarse intents.

Next, the translation layer 104b may translate 154 the fine grained intents to a set of resources needed to carry out a user-specified workload. At this stage, the set of resources may comprise an idealized set that assumes any and all needed resources are available. The RMS 104c may then consult 156 the resource inventory 104d to determine what resources are actually available for the workload. That is, in practice, it may not be the case that the ideal resource set is available, such that the RMS 104c will identify, from the resources actually available, what set of resources is the best match for the workload. This best available set may be determined with reference to constraints such as an SLA (service level agreement). That is, the best available set may only be selected if it is adequate to perform the workload while also meeting the SLA requirements. If external constraints cannot be met, the method 150 may iterate until an acceptable set of resources is available.

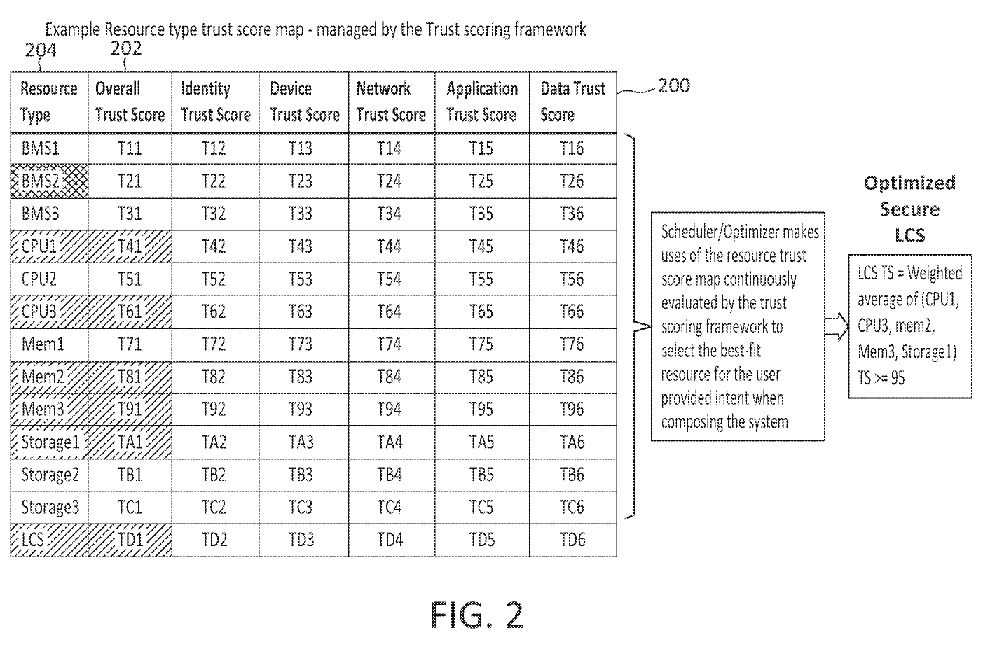

In an embodiment, only those resources with an acceptable trust score may be selected for use as part of the LCS 112. If one or more of the resources in the set do not have acceptable trust scores, such as trust scores that meet or exceed a defined threshold, the LCS 112 may not be composed until the scores change, and/or until alternative resources become available. Further details concerning resource trust scores, and a resource trust score map, are provided in the discussion of FIG. 2, below. As shown in FIG. 1, and references 110 and 114 in particular, in an embodiment, not all individual components of a computing resource 110 necessarily contribute to the trust score for the LCS 112. For example, the ‘Memory1’ of BMS1 does not contribute to the trust score of LCS 112. This may be because, for example, that component is not expected to be employed as part of the LCS 112, or there are no trust concerns regarding that component.

Once an acceptable set of resources has been identified by the RMS 104c, and as part of the operation 156, information identifying the set of resources may be passed to the scheduler 104e. The scheduler 104e may then schedule 158 the identified resources, which together form a composable architecture, that is, the LCS 112, for performance of the workload.

### C.3 Aspects of an example resource type trust score map

With attention now to FIG. 2, an example resource type trust score map, or ‘map,’ 200 according to one embodiment is disclosed. In an embodiment, the map 200 may be managed by a TSF, such as the TSF 106. The map 200 may, or may not, encompass all possible resources, whether available or not, of a resource pool. In an embodiment, only available resources are listed in the map 200.

The map 200 may include an overall trust score 202 for each of one or more resource types 204. The overall trust score 202 may be a composite of various trust scores relating to a particular resource type 204. Thus, for example, the overall trust score 202 for the resource BMS1 may comprise an identity trust score, a device trust score, a network trust score, an application trust score, and a data trust score. These examples demonstrate that since the controls/policies for each domain are different, an embodiment may measure compliance, such as by creating a trust score, with the policies within a domain, as well as an overall security posture of the environment. This overall trust score may comprise a sum of the individual domain scores. Thus, when a user or other entity seeks to compose a system, the user can specify a desired overall score, or take a more granular approach and ask for specific individual scores such as, for example, for identity and data.

In this regard, it is noted that Zero Trust is a set of design principes for implementing security controls in a specific environment. Because Zero Trust is policy driven, a user may define the configuration setting and/or run time access controls for data/applications/resources in what are sometimes referred to as policies. However, since there are many types of security controls and, accordingly, policies, it is often useful to consider specific domains of security. For example, controls/policies for identity verification and access management will be different than controls/policies for data, or for networking. In Zero Trust these different domains of security are referred to as ‘pillars.’ Thus, the columns in FIG. 2, namely, Identity, Device, Network, Application, Data, indicate the names of these pillars.

As further indicated in the map 200, there may be multiple instances of a particular resource type 204. Thus, in the example map 200, there are 3 BMS devices, 3 CPUs, 3 memory devices, and 3 storage devices. Each of these resources has a respective overall trust score 202, and an optimized, secure, LCS may defined by selecting, from one or more of the resource groups, the resource(s) with the best overall trust scores. Even if a resource has the best trust score of its group, that resource may not be selected if its trust score does not meet or exceed a threshold trust score.

In the example of FIG. 2, the dark shaded resources are selected to compose the LCS. In particular, a scheduler/optimizer, such as the scheduler 104e (FIG. 1) makes use of the map 200, continuously evaluated by a trust scoring framework such as the TSF 106 (FIG. 1), to select the best-fit resource set, for the user provided intent, when composing the LCS. Thus, as shown in the example of FIG. 2, the LCS is composed of CPU1, CPU3, Mem2, Mem3, and Storage1. Among other things then, the example map 200 enables selection of a best fit group of available resources, each with an acceptable trust score, for composition of an LCS with an aggregate trust score which indicates that the LCS conforms with applicable requirements, such as security requirements for example.

### D. Further discussion

As disclosed herein, one or more embodiments may possess various useful features and aspects, although no embodiment is required to possess any of such features or aspects. The following examples are illustrative, but not exhaustive.

An embodiment provides the ability to create an evidence-based, highly secure and trustworthy composable environment for the deployment and execution of sensitive workloads. A method according to an embodiment creates a composed system that is aligned with the user recommended trust score criteria, such as for ZT compliant devices or infrastructure, to be built from disaggregated infrastructure resources irrespective of their geographic locations or resource manufacturer. An embodiment enables policy enforcement for access requests at the most granular (sub)component level using the trust scoring framework. This enables precise anomaly detection correlated to the drifts in trust scores of the overall composed system and/or drifts in trust scores of individual system components. A method according to an embodiment enables chargeback to a customer or other user for utilizations of secure composed systems and their underlying components (CPU, GPU, memory, storage) in a multi-tenant ZT environments.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.
Embodiment 1. A method, comprising: receiving a user request that identifies base requirements needed for running a workload; translating the base requirements to a list of computing resources; identifying, from a resource inventory, which of the computing resources are available; selecting, based on respective trust scores of the computing resources, one or more of the available computing resources from the resource inventory; and composing a logical system that comprises the selected computing resources and is operable to execute the workload.
Embodiment 2. The method as recited in any preceding embodiment, wherein the selected computing resources are a best fit for running the workload, given the available computing resources.
Embodiment 3. The method as recited in any preceding embodiment, wherein the logical system is composed ad-hoc in response to the user request.
Embodiment 4. The method as recited in any preceding embodiment, wherein only those computing resources whose trust score meets or exceeds a threshold trust score are selected for inclusion in the logical system.
Embodiment 5. The method as recited in any preceding embodiment, wherein the user request comprises a user recommended trust score for the logical system.
Embodiment 6. The method as recited in any preceding embodiment, wherein the workload is performed in a ZT (zero trust) environment by the logical system.
Embodiment 7. The method as recited in any preceding embodiment, wherein the trust scores enable policy enforcement at an individual computing resource level.
Embodiment 8. The method as recited in any preceding embodiment, wherein performance of the logical system is monitored for anomaly detection.
Embodiment 9. The method as recited in any preceding embodiment, wherein the computing resources comprise physical and logical resources of a ZT environment, and the trust scores are computed by a trust scoring framework using a graph model of the physical and logical resources.
Embodiment 10. The method as recited in any preceding embodiment, wherein the logical system has a trust score that is an aggregate of the respective trust scores of the selected computing resources.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

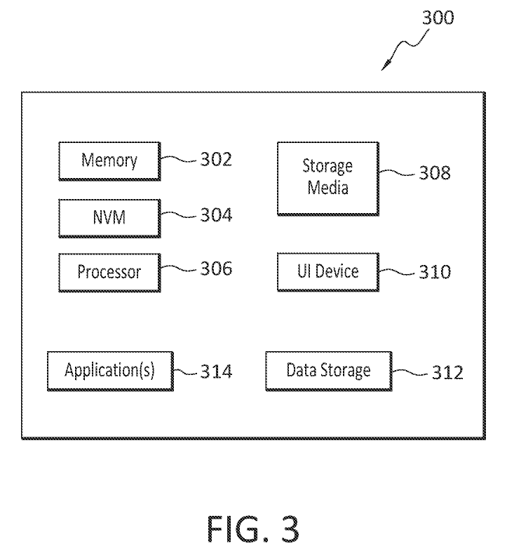

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306 and/or accelerators such as GPUs (graphics processing units), non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving a user request that identifies base requirements needed for running a workload;
translating the base requirements to a list of computing resources;
identifying, from a resource inventory, which of the computing resources are available;
selecting, based on respective trust scores of the computing resources, one or more of the available computing resources from the resource inventory; and
composing a logical system that comprises the selected computing resources and is operable to execute the workload.

2. The method as recited in claim 1, wherein the selected computing resources are a best fit for running the workload, given the available computing resources.

3. The method as recited in claim 1, wherein the logical system is composed ad-hoc in response to the user request.

4. The method as recited in claim 1, wherein only those computing resources whose trust score meets or exceeds a threshold trust score are selected for inclusion in the logical system.

5. The method as recited in claim 1, wherein the user request comprises a user recommended trust score for the logical system.

6. The method as recited in claim 1, wherein the workload is performed in a ZT (zero trust) environment by the logical system.

7. The method as recited in claim 1, wherein the trust scores enable policy enforcement at an individual computing resource level.

8. The method as recited in claim 1, wherein performance of the logical system is monitored for anomaly detection.

9. The method as recited in claim 1, wherein the computing resources comprise physical and logical resources of a ZT environment, and the trust scores are computed by a trust scoring framework using a graph model of the physical and logical resources.

10. The method as recited in claim 1, wherein the logical system has a trust score that is an aggregate of the respective trust scores of the selected computing resources.

11. A non-transitory storage medium having stored therein instructions that are executable by one or more hardware processors to perform operations comprising:
receiving a user request that identifies base requirements needed for running a workload;
translating the base requirements to a list of computing resources;
identifying, from a resource inventory, which of the computing resources are available;
selecting, based on respective trust scores of the computing resources, one or more of the available computing resources from the resource inventory; and
composing a logical system that comprises the selected computing resources and is operable to execute the workload.

12. The non-transitory storage medium as recited in claim 11, wherein the selected computing resources are a best fit for running the workload, given the available computing resources.

13. The non-transitory storage medium as recited in claim 11, wherein the logical system is composed ad-hoc in response to the user request.

14. The non-transitory storage medium as recited in claim 11, wherein only those computing resources whose trust score meets or exceeds a threshold trust score are selected for inclusion in the logical system.

15. The non-transitory storage medium as recited in claim 11, wherein the user request comprises a user recommended trust score for the logical system.

16. The non-transitory storage medium as recited in claim 11, wherein the workload is performed in a ZT (zero trust) environment by the logical system.

17. The non-transitory storage medium as recited in claim 11, wherein the trust scores enable policy enforcement at an individual computing resource level.

18. The non-transitory storage medium as recited in claim 11, wherein performance of the logical system is monitored for anomaly detection.

19. The non-transitory storage medium as recited in claim 11, wherein the computing resources comprise physical and logical resources of a ZT environment, and the trust scores are computed by a trust scoring framework using a graph model of the physical and logical resources.

20. The non-transitory storage medium as recited in claim 11, wherein the logical system has a trust score that is an aggregate of the respective trust scores of the selected computing resources.
